(19) United States
(12) Patent Application Publication
(10) Pub. No.: US 2013/0008383 A1
(43) Pub. Date: Jan. 10, 2013

(54) Squirrel proof bird feeder

(76) Inventor: Hua Tu, Changhua (TW)

(21) Appl. No.: 13/135,429

(22) Filed: Jul. 5, 2011

(51) Int. Cl. A01K 39/01

(52) U.S. Cl. 119/51.01

(57) ABSTRACT

A squirrel proof bird feeder includes a hanger device, a bird feeder container attached to the hanger device, and a shield attached to the hanger device and located above the bird feeder container, and the shield includes two shielding members each having one or more latching members, and the latching members of the shielding members are engageable with each other for securing the shielding members together and for attaching the shield to the hanger device directly without disassembling or disengaging the hanger device or the bird feeder container from the hanging cable. The shield includes an opening for engaging with the hanger device, and the latching members are selected from a lock tab, or a latch.

### BACKGROUND OF THE INVENTION

1. Field of the Invention

The present invention relates to a squirrel proof bird feeder, and more particularly to a squirrel proof bird feeder including a foldable shield for decreasing the package volume and for being folded and stored in a compact folding or storing structure.

2. Description of the Prior Art

Typical squirrel proof bird feeders comprise a covering sheet or baffle or dung shield attached or coupled to a supporting or hanging cable, and disposed or located above a bird feeder container for preventing the bird feeders from being interfered by the squirrels and other rodent animals and for preventing the birds from being attacked by the squirrels and other rodent animals.

For example, U.S. Pat. No. 4,523,546 to Latham, U.S. Pat. No. 5,207,180 to Graham, U.S. Pat. No. 6,591,781 to Hardison, U.S. Pat. No. 6,986,322 to Lumpkin, and U.S. Pat. No. 7,347,162 to Zieff et al. disclose several of the typical squirrel proof bird feeders each comprising a bird feeder container attached or coupled to a supporting tree or the like with a hanging cable and/or a hanger loop and/or a hanger handle, and a covering sheet or baffle or dung shield attached or coupled to the hanging cable and disposed or located above a bird feeder container for shielding and protecting the birds to safely get their food.

However, the covering sheet or baffle or dung shield of the typical squirrel proof bird feeders each include a one-integral piece structure having a great area or large volume that may not be folded or stored in a compact folding or storing structure and that may greatly increase the storing or transportation cost for the typical squirrel proof bird feeders. In addition, the typical squirrel proof bird feeders which include a large volume may not be easily carried with the user.

The present invention has arisen to mitigate and/or obviate the afore-described disadvantages of the conventional squirrel proof bird feeders.

### SUMMARY OF THE INVENTION

The primary objective of the present invention is to provide a squirrel proof bird feeder including a shield having a foldable structure for decreasing the package volume and for allowing the shield of the bird feeder to be folded or stored in a compact folding or storing structure.

In accordance with one aspect of the invention, there is provided a squirrel proof bird feeder comprising a hanger device, a bird feeder container attached to the hanger device, and a shield attached to the hanger device and located above the bird feeder container, and the shield including two shielding members each having at least one latching member, and the latching member of the shielding members being engageable with each other for securing the shielding members together and for attaching the shield to the hanger device.

The shield includes an opening formed therein for engaging with the hanger device. The latching member is selected from a lock tab, or a latch. The latch includes a slot formed therein for forming two resilient or ratchet legs.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a squirrel proof bird feeder in accordance with the present invention;

FIG. 2 is a partial exploded view of the squirrel proof bird feeder;

FIG. 3 is a plan schematic view of the squirrel proof bird feeder, in which a portion of the bird feeder has been cut off for showing the inner structure of the bird feeder; and

FIG. 4 is an enlarged partial cross sectional view of the squirrel proof bird feeder.

### DETAILED DESCRIPTION OF THE PREFERRED EMBODIMENT

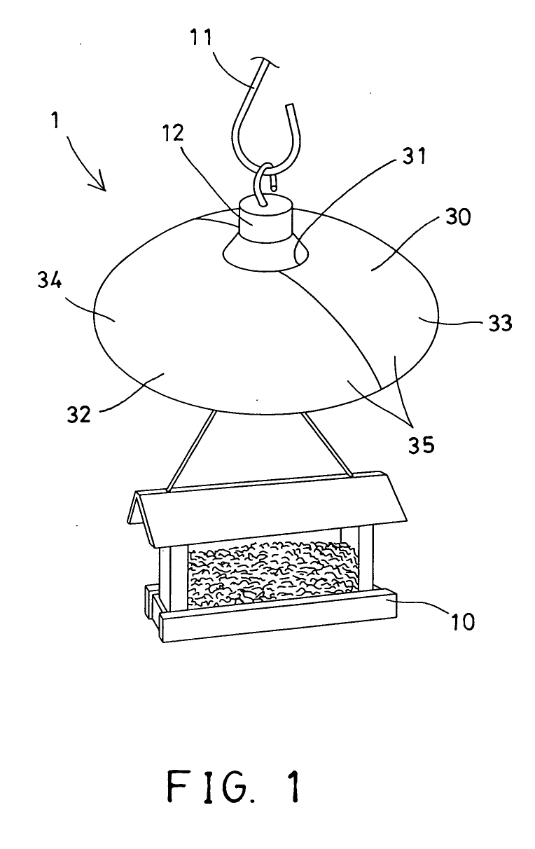

Referring to the drawings, and initially to FIG. 1, a squirrel proof bird feeder 1 in accordance with the present invention comprises a bird feeder container 10 attached or coupled to a supporting tree (not shown) or the like with a hanging cable 11 and/or a hanger loop or hanger handle or hanger device 12, and a covering sheet or baffle or dung shield 30 attached or coupled to the hanging cable 11 and/or the hanger device 12 and disposed or located above the bird feeder container 10 for shielding and protecting the birds to safely get their food and for preventing the birds from being interfered or attacked by the squirrels and other rodent animals.

As shown in FIGS. 1-3, the shield 30 includes an opening 31 formed in the middle or center portion thereof for receiving or engaging with the hanging cable 11 and/or the hanger device 12 and for suitably attaching or mounting or securing onto the hanging cable 11 and/or the hanger device 12, and includes two portions or segments or half shielding members 32, 33 to be folded or stored in a compact folding or storing structure and to be assembled or mounted or secured or coupled together to form a substantially dome-shaped structure. However, the shape of the shield 30 may be formed or shaped into various kinds of shapes or structures.

The shielding members 32, 33 each include a curved or semi-circular outer skirt 34, and an inner edge or portion 35, in which the inner portions 35 of the shielding members 32, 33 include a predetermined shape or structure for allowing the inner edges or portions 35 of the shielding members 32, 33 to be mated and contacted and engaged with each other when required, or when the shielding members 32, 33 are to be assembled or mounted or secured or coupled together to form the substantially dome-shaped structure at a working status.

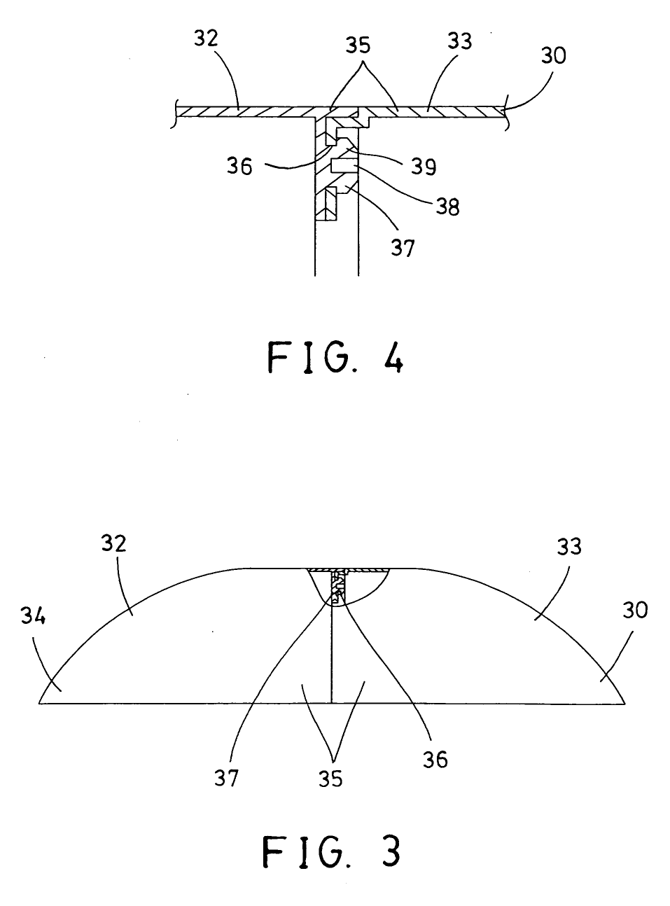

The shielding members 32, 33 each further include one or more (such as two) lock openings or tabs or latching members 36, and/or one or more (such as two) latches or latching members 37, and arranged for allowing the lock tabs 36 and the latches 37 or the latching members 36, 37 of the two shielding members 32, 33 to be mated and engaged with each other, and for allowing the two shielding members 32, 33 to be assembled or mounted or secured or coupled together to solidly and stably form the dome-shaped working structure as shown in FIGS. 1 and 3. As best shown in FIG. 4, the latches or latching members 37 each may include a channel or slot 38 formed therein for forming or defining two resilient and ratchet legs 39 and for allowing the ratchet legs 39 of the latches or latching members 37 to be easily and quickly engaged with the lock tabs or latching members 36 and to be prevented from being disengaged from each other inadvertently.

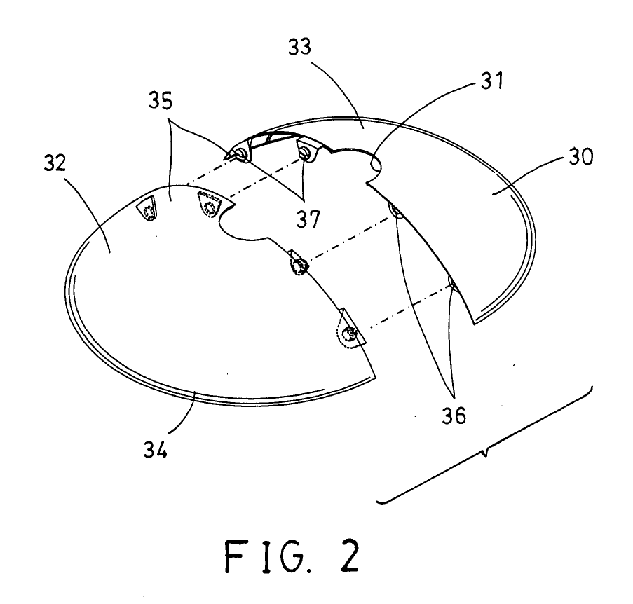

In operation, as shown in FIG. 2, before assembled or mounted or secured or coupled together, the two shielding members 32, 33 are separated or disengaged from each other and may be superposed and engaged with each other at a compact folding or storing structure. In addition, the two shielding members 32, 33 may be easily and quickly mated and engaged with each other and directly and readily attached or mounted or secured onto the hanging cable 11 and/or the hanger device 12 without disassembling or . disengaging the hanger device 12 and/or the bird feeder container 10 from the hanging cable 11.

Accordingly, the squirrel proof bird feeder in accordance with the present invention includes a shield having a foldable structure for decreasing the package volume and for allowing the shield of the bird feeder to be folded or stored in a compact folding or storing structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A squirrel proof bird feeder comprising:
a hanger device,
a bird feeder container attached to said hanger device, and
a shield attached to said hanger device and located above said bird feeder container, said shield including an opening formed therein for engaging with said hanger device, and said shield including a first shielding member having a lock tab as a latching member, a second shielding member having a latch as a latching member, and said lock tab and said latch of said first and said second shielding members being engageable with each other for securing said first and said second shielding members together and for attaching said shield to said hanger device, and said latch including a slot formed therein for forming two legs and for engaging with said lock tab.

2-5. (canceled)
